(19) United States
(12) Patent Application Publication
(10) Pub. No.: US 2003/0234497 A1
(43) Pub. Date: Dec. 25, 2003

(54) Gas seal structure for high-temperature denitration apparatus

(75) Inventors: Hitoshi Koike, Funabashi-shi (JP); Masahiro Takeuchi, Funabashi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ishikawajima-Harima Heavy Industries Co., Ltd., Tokyo (JP)

(21) Appl. No.: 10/444,956

(22) Filed: May 27, 2003

(30) Foreign Application Priority Data
Jun. 20, 2002 (JP) 2002-180427

(51) Int. Cl. F16J 15/02

(52) U.S. Cl. 277/637

(57) ABSTRACT

Seal plates are mounted to and extend from a rim of a frame body to an inner surface of a casing so as to prevent short pass of exhaust gas. Seal guides are mounted via heat shield bases on the inner surface of the casing to receive the seal plates such that the seal plates are slidable upon thermal expansion of the frame body. Heat of hot exhaust gas passing through the casing and trying to propagating via the seal guides to the casing is shielded by the heat shield bases. As a result, no hot spots are produced on portions of the casing where the seal guides are mounted.

### BACKGROUND OF THE INVENTION

1. Field of the Invention

The present invention relates to a gas seal structure for a high-temperature denitration apparatus.

2. Description of the Related Art

A conventional denitration apparatus for boiler exhaust gas generally comprises, as shown in FIGS. 1 and 2, a box-shaped casing 1 with front and rear open ends for passage of exhaust gas from a boiler (not shown) and a frame body 2 in the casing 1.

The frame body 2 comprises a plurality of vertical frame members 3 erected in a spaced-apart relationship widthwise and in a direction of exhaust gas flow of the casing 1 and a plurality of horizontal frame members 4 fixed to the vertical frame members 3 through welding into a latticework. Thus, spaces 5 to be filled or charged with catalysts are formed in a plurality of widthwise rows and in a plurality of vertical stages within the casing 1, brace members 6 being welded to interconnect slantwise the frame members 3 and 4 for reinforcement against horizontal forces generated for example in an earthquake. A plurality of (two in the example shown in FIG. 2) such frame bodies 2 with the same construction are arranged and interconnected in the direction of exhaust gas flow.

The casing 1 is internally lined with thermal insulation material 7, and upon operation, temperature difference is caused between the casing 1 and the frame body 2 so that a degree in thermal expansion of the latter is greater than that of the former. Such difference in thermal expansion between the casing 1 and the frame body 2 upon operation may be absorbed such that the frame body 2 is supported in the casing 1 partly by fixed supports 8 and partly by slide supports 9 so as to make the frame body 2 slidable widthwise and in the direction of exhaust gas flow of the casing 1.

A catalyst port 11 with an openable lid 10 protrudes from a top of the casing 1. With the lid 10 being opened, catalyst modules 12 each charged with catalysts are suspended for example by cranes as shown in FIG. 2 and are set in the spaces 5 within the frame bodies 2.

Short pass of the exhaust gas through between an inner surface of the casing 1 and a rim of the frame body 2 would causes the short-passed exhaust gas not to pass through the catalysts, resulting in deterioration of denitration performance. To overcome this, conventionally, as shown in FIGS. 3 and 4, seal plates 30 for prevention of short pass of the exhaust gas are mounted to and extend from the rim of the frame body 2 to the inner surface of the casing 1 which receives the seal plates 30 through seal guides 31 mounted thereon such that the seal plates 30 are slidable upon thermal expansion of the frame body 2.

As to the seal plate 30 mounted to a bottom of the frame body 2, since substantially no consideration is needed for vertical displacement of the seal plate 30 upon thermal expansion of the frame body 2, the plate 30 is trailed down from the bottom of the frame body 2 with its low end folded forward to contact the thermal insulation material 7 on a bottom of the casing 7 as shown in FIG. 5; as to the seal plate 30 mounted to an upper portion of the frame body 2, as shown in FIG. 6, the seal guides 31 mounted below a stopper 40 on the inner surface of the casing 1 receive a tip end of the seal plate 30 extending upward from the frame body 2 such that the seal plate 30 is slidable to the seal guides 31.

Recently, a gas turbine is frequently used for generation of electricity and in such a case, exhaust gas from the gas turbine must be denitrated. To this end, it has been envisaged that, as a high-temperature denitration apparatus for gas-turbine exhaust gas, the above-mentioned denitration apparatus for boiler exhaust gas is utilized, with no structural change and with material of which the members 3, 4 and 6 are made being changed from carbon steel to stainless steel.

In the case of the high-temperature denitration apparatus for gas-turbine exhaust gas, though extremely hot exhaust gas passes through the casing 1, the casing 1 is retained substantially to ambient temperature by the thermal insulation material 7 on the inner surface of the casing 1.

However, because of the seal guides 31 directly mounted on the inner surface of the casing 1 as shown in FIG. 4, thermal conduction through the seal guides 31 may disadvantageously produce hot spots with temperature of more than 200° C. on portions of the casing 1 where the seal guides 31 are mounted.

As to the seal guides 31 directly mounted to an upper portion of the casing 1, as is clear from FIG. 6, they are hardly in direct contact with the exhaust gas and extend from the casing 1 in a bent form hard for thermal conduction; therefore, there is substantially no fear of a hot spot being produced on the upper portion of the casing 1 where the seal guides 31 are mounted.

The invention was made in view of the above and has its object to provide a gas seal structure for a high-temperature denitration apparatus which can suppress thermal conduction through seal guides to minimum and can prevent hot spots from being produced on the casing.

### BRIEF SUMMARY OF THE INVENTION

The invention is directed to a gas seal structure for a high-temperature denitration apparatus which comprises a box-shaped casing with front and rear open ends for passage of hot exhaust gas and internally lined with thermal insulation material, a frame body within said casing, seal plates mounted to and extending from a rim of said frame body to an inner surface of the casing so as to prevent short pass of the exhaust gas, and seal guides mounted via heat shield bases on the inner surface of the casing, said seal guides receiving the seal plates such that the seal plates are slidable upon thermal expansion of the frame body.

The gas seal structure for the high-temperature denitration apparatus thus constructed has the following effect.

Heat of the hot exhaust gas passing through the casing makes to propagate via the seal guides to the casing. However, because of the heat shield bases being interposed between the casing and the seal guides, such heat conduction is suppressed to minimum by the heat shield bases, whereby no hot spots are produced on portions of the casing where the seal guides are mounted.

Each of the heat shield bases may comprise stud bolts protruded from the inner surface of the casing and a base plate fixed to tips of the stud bolts.

Next, a preferred embodiment of the invention will be described in conjunction with the drawings.

### BRIEF DESCRIPTION OF THE DRAWINGS

FIG. 1 is a front view of a conventional denitration apparatus;

FIG. 2 is a view looking in the direction of arrows II in FIG. 1;

FIG. 3 is an enlarged fragmentary vertical sectional front elevation of a conventional gas seal structure for the denitration apparatus;

FIG. 4 is an enlarged fragmentary horizontal sectional view taken along lines IV-IV in FIG. 3;

FIG. 5 is an enlarged fragmentary sectional side elevation taken along lines V-V in FIG. 3 for showing a bottom of the conventional gas seal structure for the denitration apparatus;

FIG. 6 is an enlarged fragmentary sectional side elevation taken along line VI-VI in FIG. 3 for showing an upper portion of the conventional gas seal structure for the denitration apparatus;

FIG. 7 is an enlarged fragmentary vertical sectional front elevation of an embodiment of the invention; and

FIG. 8 is an enlarged fragmentary sectional side elevation taken along lines VIII-VIII in FIG. 7.

### DETAILED DESCRIPTION OF THE PREFERRED EMBODIMENT

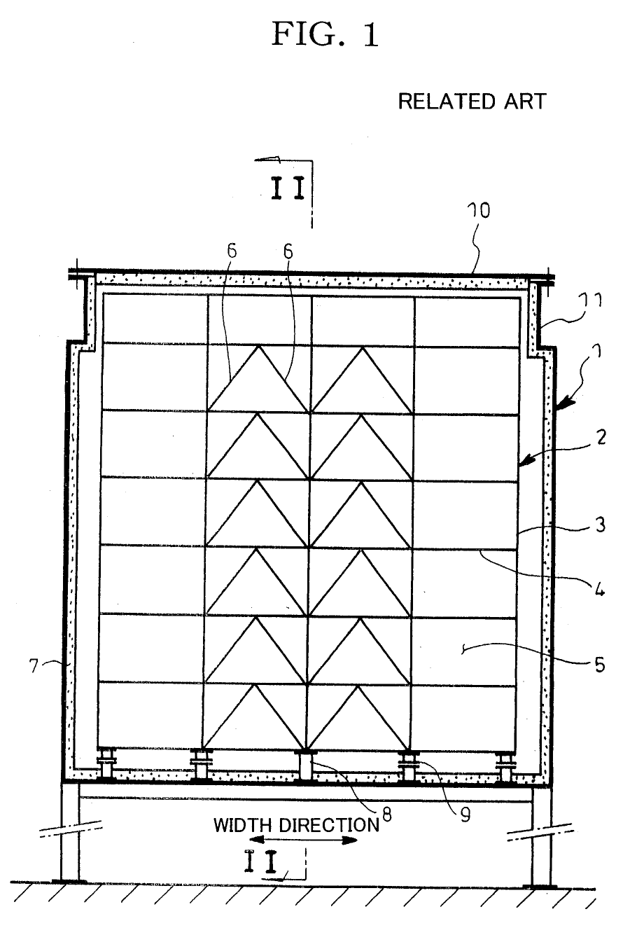

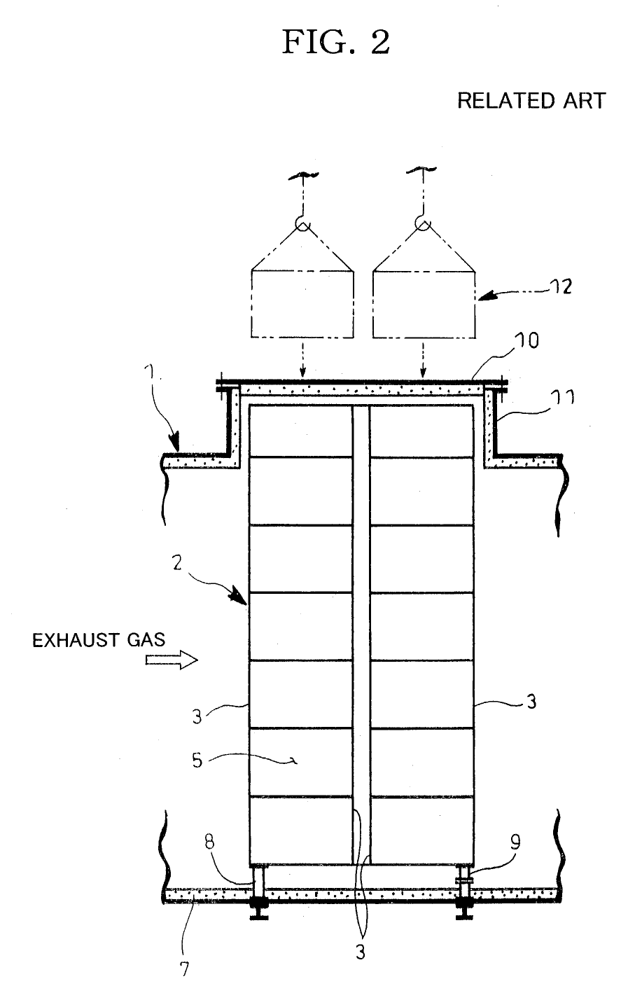

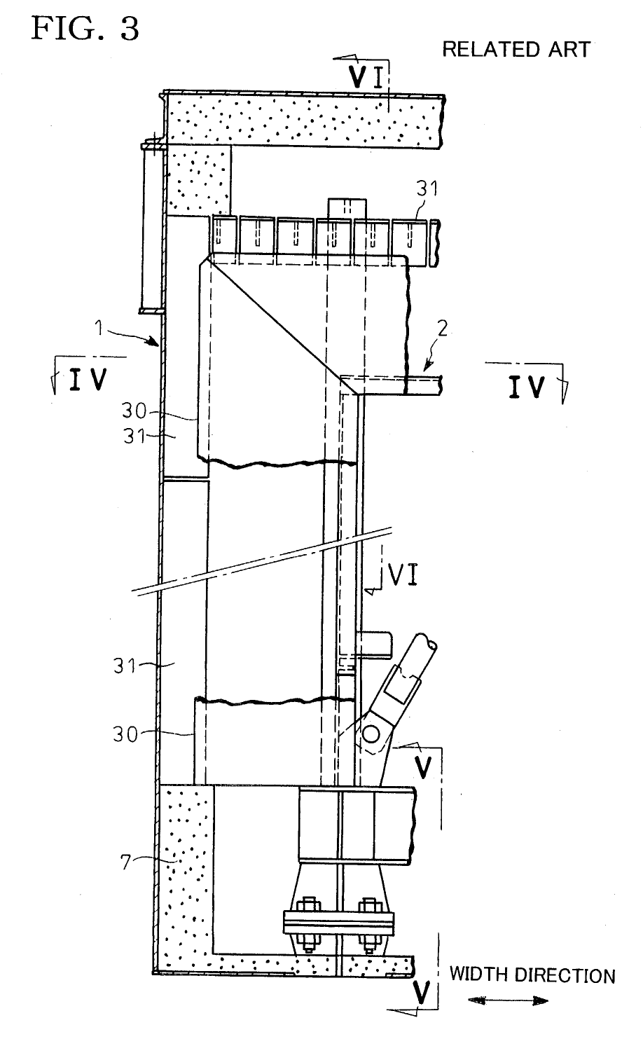

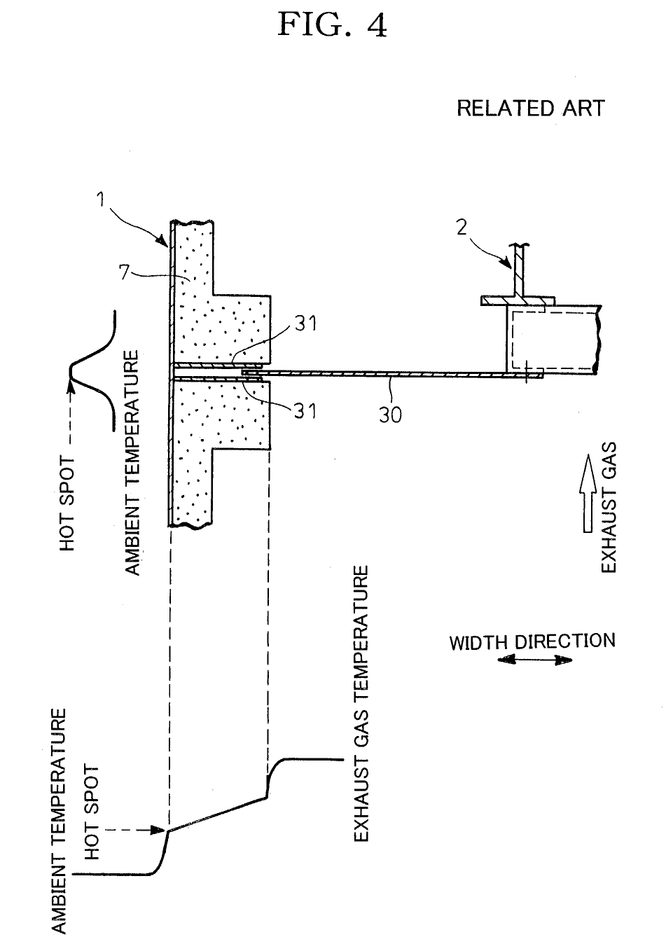

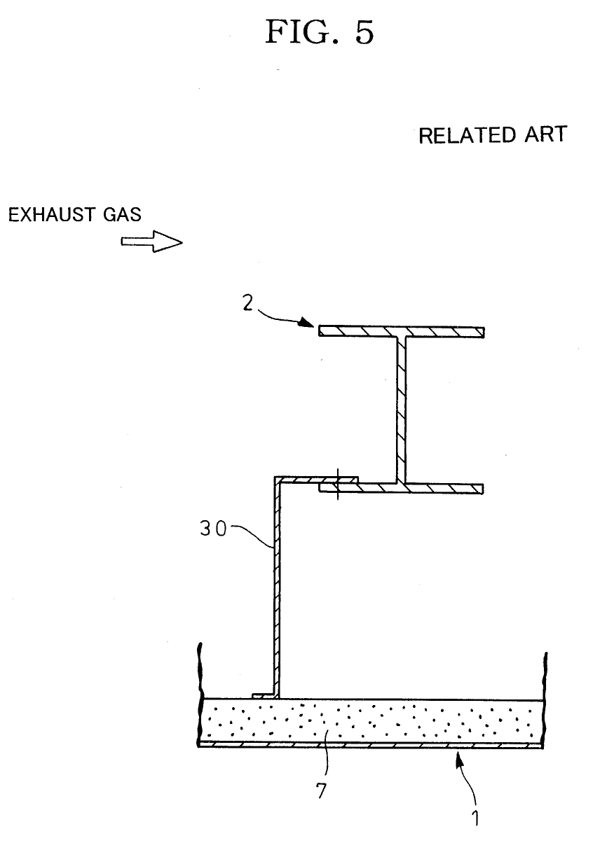

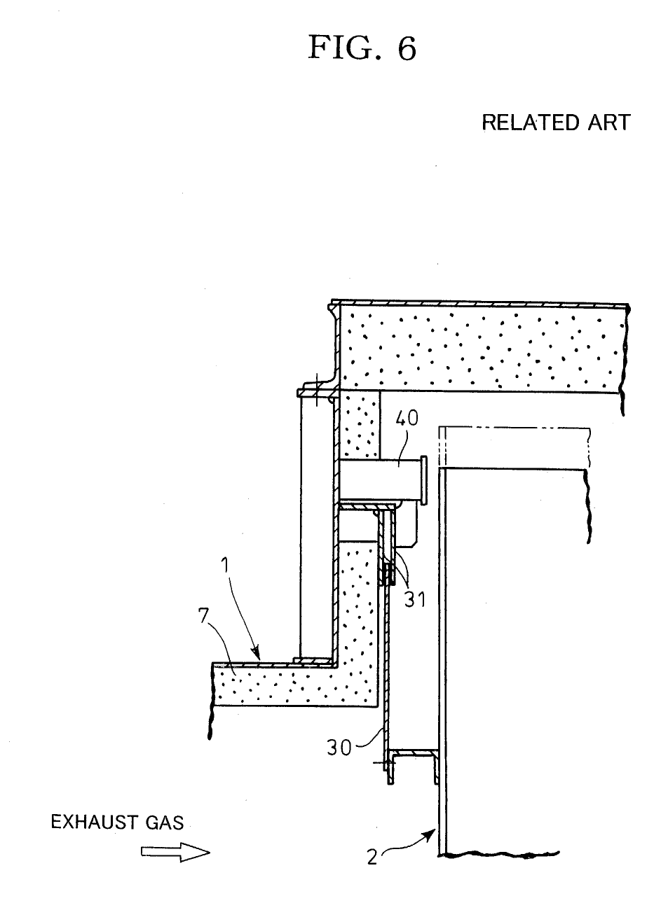

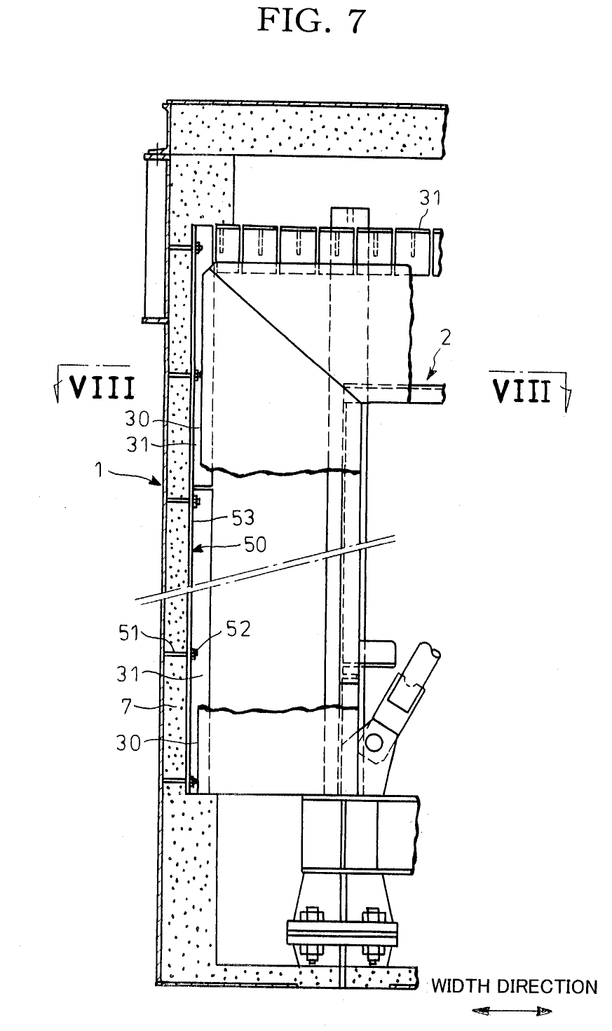

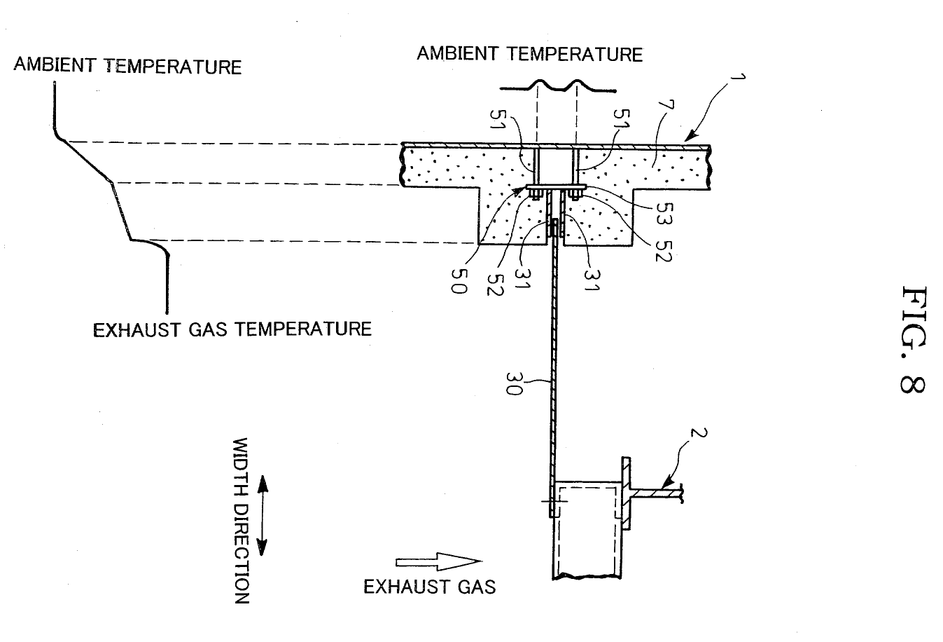

FIGS. 7 and 8 show an embodiment of the invention in which parts similar to those in FIGS. 1 to 6 are represented by the same reference numerals and which is basically similar in structure to that in the related art shown in FIGS. 1 to 6. The embodiment resides in that, as shown in FIGS. 7 and 8, seal plates 30 are mounted to and extend from a rim of the frame body 2 to an inner surface of the casing 1 so as to prevent short pass of the exhaust gas and that seal guides 31 are mounted via heat shield bases 50 on the inner surface of the casing 1, said seal guides 31 receiving the seal plates 30 such that the seal plates 30 are slidable upon thermal expansion of the frame body 2.

Each of the heat shield bases 50 comprises stud bolts 51 extruded from the inner surface of the casing 1 and a base plate 53 fixed to tips of the stud bolts 51 by screwing nuts 52 up. The seal guides 31 are fixed to the base plate 53.

Next, the mode of operation of the embodiment will be described.

Heat of the hot exhaust gas passing through the casing 1 tried to propagate via the seal guides 31 to the casing 1. However, because of the heat shield bases 50 interposing between the casing 1 and the seal guides 31, heat conduction is suppressed to minimum by the heat shield bases 50 and no hot spots with temperature of more than 200° C. are produced on the portions of the casing 1 where the seal guides 31 are mounted. Temperature of the portions of the casing 1 where the stud bolts 51 of the heat shield bases 50 are mounted may be as low as about 50-70° C.

Thus, heat conduction through the seal guides 31 is suppressed to minimum and hot spots are prevented from being produced on the casing 1.

It is to be understood that the present invention is not limited to the above-mentioned embodiment and that various changes and modifications may be made without deferring from the scope and spirit of the invention.

As is clear from the foregoing, according to a gas seal structure for a high-temperature denitration apparatus in the invention, heat conduction through the seal guides is suppressed to minimum and hot spots are prevented from being produced on the casing.

What is claimed is:

1. A gas seal structure for a high-temperature denitration apparatus comprising a box-shaped casing with front and rear open ends for passage of hot exhaust gas and internally lined with thermal insulation material, a frame body within said casing, seal plates mounted to and extending from a rim of said frame body to an inner surface of the casing so as to prevent short pass of the exhaust gas, and seal guides mounted via heat shield bases on the inner surface of the casing, said seal guides receiving the seal plates such that the seal plates are slidable upon thermal expansion of the frame body.

2. A gas seal structure according to claim 1, wherein each of said heat shield bases comprises stud bolts extruded from the inner surface of the casing and a base plate fixed to tips of said stud bolts.
